(19) United States
(12) Patent Application Publication
(10) Pub. No.: US 2013/0268142 A1
(43) Pub. Date: Oct. 10, 2013

(54) Vehicle Intelligent Key Device and Vehicle Comprising the Same

(71) Applicants: SHENZHEN BYD AUTO R&D COMPANY LIMITED, Shenzhen (CN); BYD COMPANY LIMITED, Shenzhen (CN)

(72) Inventors: Xiaowen DU, Shenzhen (CN); Yongzeng ZHANG, Shenzhen (CN); Yilin ZHONG, Shenzhen (CN); Bo FAN, Shenzhen (CN)

(21) Appl. No.: 13/857,720

(22) Filed: Apr. 5, 2013

(30) Foreign Application Priority Data
Apr. 6, 2012 (CN) 201220143515.3

(51) Int. Cl. G06F 17/00

(52) U.S. Cl. CPC G06F 17/00
USPC 701/2

(57) ABSTRACT

A passenger vehicle intelligent key device comprises: a starting key; a direction controlling key; a wireless communication module, configured to communicate with a passenger vehicle wirelessly; and a controlling module, connected to the starting key, the direction controlling key and the wireless communication module respectively, and configured to control the wireless communication module to send a starting signal or a direction controlling signal to the passenger vehicle when the starting key or the direction controlling key is activated.

### CROSS-REFERENCE TO RELATED APPLICATION

This application claims priority to and benefit of Chinese Patent Application No. 201220143515.3, filed with the State Intellectual Property Office of P. R. China on Apr. 6, 2012, the entire contents of which are incorporated herein by reference.

### FIELD

The present disclosure generally relates to vehicular technologies and, more particularly, to a vehicle intelligent key device and a vehicle comprising the same.

### BACKGROUND

Nowadays, as the number of vehicles increases, it becomes more and more difficult to find a parking space. For densely populated cities, parking spaces for vehicles are not only in shortage but also becoming much smaller. Therefore, it is difficult for a driver to maneuver the vehicle in or out of the parking space. It is also difficult for the driver or a passenger to get in or off the vehicle when the vehicle is parked.

There is a need to control the vehicle to park or start the vehicle from outside, so that the driver does not need to get in or get off the vehicle in the narrow parking space.

### SUMMARY

According to some embodiments, there is provided a vehicle intelligent key device, comprising: a starting key; a direction controlling key; a wireless communication module, configured to communicate with a passenger vehicle wirelessly; and a controlling module connected to the starting key, the direction controlling key and the wireless communication module, and configured to control the wireless communication module to send a starting signal or a direction controlling signal to the passenger vehicle when the starting key or the direction controlling key is activated.

According to some alternative embodiments of a second broad aspect of the present disclosure, there is provided a passenger vehicle, comprising: a vehicle intelligent key device; and a vehicle controller configured to communicate with the vehicle intelligent key device. The passenger vehicle is configured to operate according to a starting signal or a direction controlling signal sent from the vehicle intelligent key device.

The above summary of the present disclosure is not intended to describe each disclosed embodiment or every implementation of the present disclosure. The following figures and detailed description more particularly exemplify illustrative embodiments. Additional aspects and advantages of the embodiments of the present disclosure will be provided in part in the following descriptions, and become apparent in part from the following descriptions, or be learned from the practice of the embodiments of the present disclosure.

### BRIEF DESCRIPTION OF THE DRAWINGS

FIG. 1 is a block diagram of a vehicle intelligent key device according to an embodiment of the present disclosure;

FIG. 2 is a schematic view of a control panel of a vehicle intelligent key device according to an embodiment of the present disclosure;

FIG. 3 is a block diagram of a vehicle according to an embodiment of the present disclosure;

FIG. 4 is a block diagram of a vehicle according to another embodiment of the present disclosure;

FIG. 5 is a flow chart of a process for starting a remote control mode of the vehicle according to an embodiment of the present disclosure;

FIG. 6 is a block diagram of a vehicle according to yet another embodiment of the present disclosure;

FIG. 7 is a flow chart of a process for controlling the vehicle to move forward according to an embodiment of the present disclosure;

FIG. 8 is a flow chart of a process for controlling the vehicle to reverse according to an embodiment of the present disclosure;

FIG. 9 is a block diagram of a vehicle according to still yet another embodiment of the present disclosure; and

FIG. 10 is a flow chart of a process for controlling the vehicle to turn left or right according to an embodiment of the present disclosure.

### DETAILED DESCRIPTION

Reference will be made in detail to embodiments of the present disclosure. The embodiments described herein with reference to accompanying drawings are explanatory and illustrative, which are used to generally describe the present disclosure. The embodiments shall not be construed to limit the present disclosure. The same or similar elements and the elements having same or similar functions are denoted by like reference numerals throughout the descriptions.

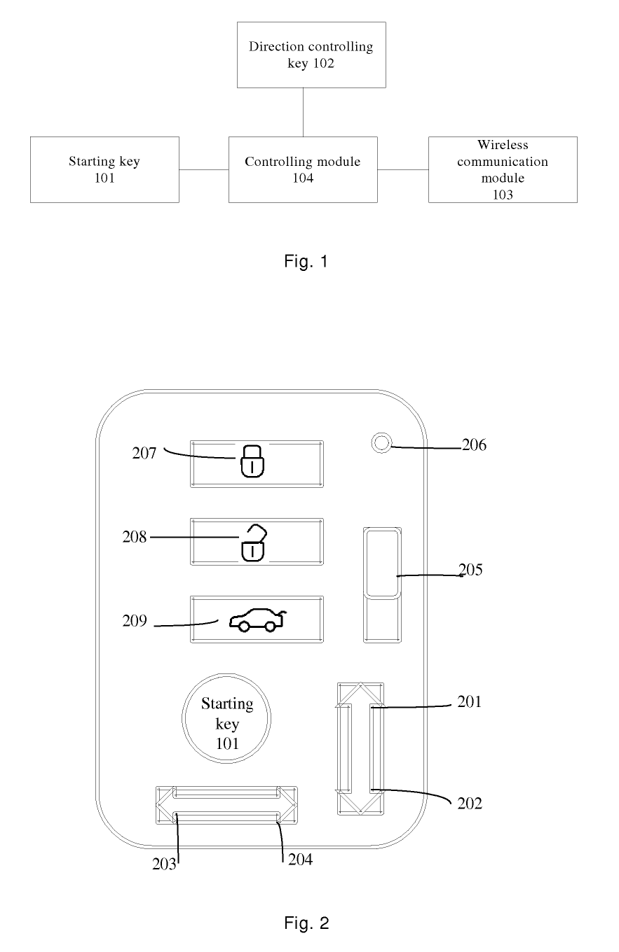

FIG. 1 is a schematic diagram of a vehicle intelligent key device 100 according to an embodiment of the present disclosure. As shown in FIG. 1, the vehicle intelligent key device according to embodiments of the present disclosure comprises a starting key 101, a direction controlling key 102, a wireless communication module 103, and a controlling module 104. The wireless communication module 103 is configured to communicate with a vehicle wirelessly. The vehicle may be a passenger vehicle. The controlling module 104 is electronically connected with the starting key 101, the direction controlling key 102, and the wireless communication module 103, and configured to control the wireless communication module 103 to send a starting signal or a direction controlling signal to the vehicle when the starting key 101 or the direction controlling key 102 is activated.

When the starting key 101 is activated by a user, for example, when the starting key 101 is pressed down for a time period greater than a first predetermined time period, the vehicle intelligent key device modulates relevant information and sends a first high-frequency starting signal. A high-frequency receiving module of the vehicle receives the first high-frequency starting signal, and then sends a starting signal to a vehicle controller of the vehicle after demodulating the first high-frequency starting signal. The vehicle controller authenticates the starting signal, and then sends out a “starting” message to control the vehicle to start. In some embodiments of the present disclosure, the first predetermined time period may be 2 seconds.

According to another embodiment, when the starting key 101 is pressed down for a shorter period of time (e.g., a time period less than the first predetermined time period), the vehicle intelligent key device modulates relevant information and sends a second high-frequency starting signal. The high-frequency receiving module of the vehicle may receive the second high-frequency starting signal, and then send an “off” signal to the vehicle controller of the vehicle after demodulating the second high-frequency starting signal. The vehicle controller authenticates the “off” signal, and then sends out an “off” message to cause the vehicle to be turned off.

FIG. 2 is a schematic view of a control panel 200 of the vehicle intelligent key device 100 according to an embodiment of the present disclosure. As shown in FIG. 2, the direction controlling key 102 may comprise at least one of a left turning key 203, a right turning key 204, a forward key 201, and a backward key 202.

When the forward key 201 is activated, for example, when the forward key 201 is pressed down by the user, the vehicle intelligent key device modulates relevant information and sends a high-frequency forward signal. Then, the high-frequency receiving module of the vehicle receives the high-frequency forward signal, and sends a forward signal to the vehicle controller of the vehicle after demodulating the high-frequency forward signal. The vehicle controller authenticates the forward signal, and then sends out a “forward” message to control the vehicle to move forward at a low speed. In one embodiment of the present disclosure, the vehicle may move forward at a speed lower than 2 km/h. When the user releases the forward key 201, the vehicle stops.

When the backward key 202 is activated, for example, when the backward key 202 is pressed down by the user, the vehicle intelligent key device modulates relevant information and sends a high-frequency backward signal. Then, the high-frequency receiving module of the vehicle receives the high-frequency backward signal and sends a backward signal to the vehicle controller of the vehicle after demodulating the high-frequency backward signal. The vehicle controller authenticates the backward signal, and then sends out a “backward” message to control the vehicle to reverse at a low speed. In one embodiment of the present disclosure, the vehicle may reverse at a speed lower than 2 km/h. When the user releases the backward key 201, the vehicle stops.

When the left turning key 203 is activated, for example, when the left turning key 203 is pressed down by the user, the vehicle intelligent key device modulates relevant information and sends a high-frequency left turning signal. Then, the high-frequency receiving module of the vehicle receives the high-frequency left turning signal, and sends a left turning signal to the vehicle controller of the vehicle after demodulating the high-frequency left turning signal. The vehicle controller authenticates the left turning signal and sends out a “left turning” message to control a steering wheel of the vehicle to turn left. When the user releases the left turning key 203, the vehicle stops turning left.

When the right turning key 204 is activated, for example, when the right turning key 204 is pressed down by the user, the vehicle intelligent key device modulates relevant information and sends a high-frequency right turning signal. Then, the high-frequency receiving module of the vehicle receives the high-frequency right turning signal and sends a right turning signal to the vehicle controller of the vehicle after demodulating the high-frequency right turning signal. The vehicle controller authenticates the right turning signal and sends out a “right turning” message to control the steering wheel of the vehicle to turn right. When the user releases the right turning key 204, the vehicle stops turning right.

The direction controlling key 102 may be effective only when the starting key 101 is activated to start a remote control mode of the vehicle. The left turning key 203, the right turning key 204, the forward key 201, and the backward key 202 may not be operated at the same time. For example, the user cannot control the vehicle to turn left or right when controlling the vehicle to move forward or backward through the forward key 201 or the backward key 202. It may be invalid to press down the left turning key 203 or the right turning key 204 during the forward or backward movement of the vehicle. Similarly, the user cannot control the vehicle to move forward or backward when controlling the vehicle to turn left or right through the left turning key 203 or the right turning key 204. Thus, it may be invalid to press down the forward key 201 or the backward key 202 during the left or right turning of the vehicle.

Referring to FIGS. 1 and 2, the vehicle intelligent key device according to embodiments of the present disclosure may further comprise a locking key 207, an unlocking key 208, a trunk opening key 209, and a holding key 205.

In one embodiment of the present disclosure, the locking key 207 is electronically connected to the controlling module 104. The controlling module 104 is configured to control the wireless communication module 103 to send a locking signal to the vehicle when the locking key 207 is activated. In other words, when the locking key 207 is activated by the user, the vehicle intelligent key device modulates relevant information and sends a high-frequency locking signal. Then, the high-frequency receiving module of the vehicle receives the high-frequency locking signal and sends the locking signal to the vehicle controller of the vehicle after demodulating the high-frequency locking signal. The vehicle controller authenticates the locking signal, and sends out a “remote locking” message. Thus, before a remote control mode of the vehicle, the vehicle can be locked according to the “remote locking” message so as to avoid any mis-operation.

In one embodiment of the present disclosure, the unlocking key 208 is connected to the controlling module 104. The controlling module 104 is configured to control the wireless communication module 103 to send an unlocking signal to the vehicle when the unlocking key 208 is activated. In other words, when the unlocking key 208 is activated by the user, the vehicle intelligent key device modulates relevant information and sends a high-frequency unlocking signal. Then, the high-frequency receiving module of the vehicle receives the high-frequency unlocking signal and sends the unlocking signal to the vehicle controller of the vehicle after demodulating the high-frequency unlocking signal. The vehicle controller authenticates the unlocking signal and sends out a “remote unlocking” message. Thus, the vehicle may be unlocked to quit the remote control mode by activating the unlocking key 208 to unlock the vehicle.

Similarly, in one embodiment of the present disclosure, the trunk opening key 209 is connected to the controlling module 104. The controlling module 104 is configured to control the wireless communication module 103 to send a trunk opening signal to the vehicle when the trunk opening key 209 is activated. In other words, when the trunk opening key 209 is activated by the user, the vehicle intelligent key device modulates relevant information and sends a high-frequency trunk opening signal. Then, the high-frequency receiving module of the vehicle receives the high-frequency trunk opening signal, and sends the trunk opening signal to the vehicle controller of the vehicle after demodulating the high-frequency trunk opening signal. The vehicle controller authenticates the trunk opening signal and sends out a “remote trunk opening” message to cause the trunk to be opened.

In one embodiment of the present disclosure, the holding key 205 is electronically connected to the controlling module 104. The controlling module 104 is configured to lock the starting key 101, the direction controlling key 102, the locking key 207, the unlocking key 208, and the trunk opening key 209 when the holding key 205 is activated. In other words, when the holding key 205 is activated by the user, the vehicle intelligent key device modulates relevant information and sends a high-frequency holding signal. Then, the high-frequency receiving module of the vehicle receives the high-frequency holding signal, and sends the holding signal to the vehicle controller of the vehicle after demodulating the high-frequency holding signal. The vehicle controller authenticates the holding signal, and sends out a “holding” message to control the vehicle not to execute any action according to the signal sent from the vehicle intelligent key device (for example, the starting signal or the direction controlling signal) when the vehicle is already in a desired condition (for example, the vehicle is already parked in a given location). Thus, the mis-operation may be avoided.

In some embodiments of the present disclosure, the vehicle intelligent key device may further comprise an indicator 206 configured to indicate various statuses of the vehicle intelligent key device. The indicator 206 may be red, blue, green, yellow, or any other colors known in the art. Furthermore, the indicator 206 may be activated to emit light in a chosen color for a fourth predetermined time period whenever the vehicle intelligent key device is operated to send out a signal.

In one embodiment of the present disclosure, the fourth predetermined time period may be 250 milliseconds. When the indicator 206 emits light, it indicates that the vehicle intelligent key device operates normally. When the indicator 206 fails to emit light, it may indicate that the vehicle intelligent key device is low on power or the signal is too weak.

In one embodiment of the present disclosure, the vehicle intelligent key device may further comprise a transponder (not shown) configured to communicate with the vehicle when the wireless communication module 103 is interfered by other signals or environmental factors. When the power of the vehicle intelligent key device is low or zero, the transponder may also provide communications between the vehicle intelligent key device and the vehicle.

With the vehicle intelligent key device according to the present disclosure, the user may control a vehicle to start, move forward/backward and turn left/right at a low speed within a visual range (such as about 10 meters around the vehicle) according to the activation of the starting key 101, the forward/backward keys and the left/right turning keys of the vehicle respectively. Thus, it is possible to realize various controlling for the vehicle outside the vehicle, and it is easy and convenient for the user to park or take a vehicle in a narrow space.

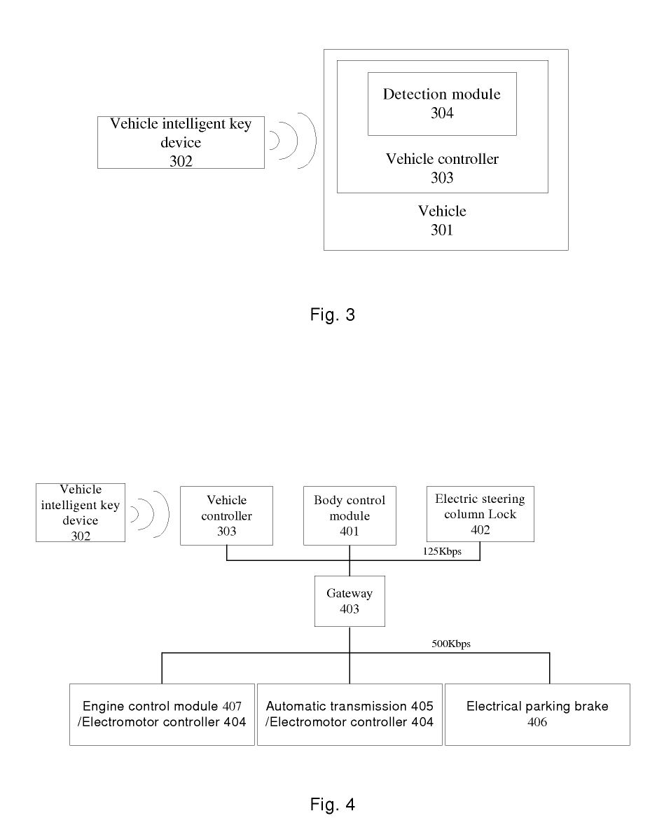

In the following, a vehicle with a vehicle intelligent key device will be described in detail with reference to FIGS. 3-10.

FIG. 3 is a block diagram of a vehicle 301 according to an embodiment of the present disclosure. The vehicle 301 may be a passenger vehicle. As shown in FIG. 3, the vehicle 301 according to embodiments of the present disclosure comprises a vehicle intelligent key device 302 mentioned above; and a vehicle controller 303 configured to communicate with the vehicle intelligent key device 302 and to control the vehicle 301 to execute a corresponding action according to a starting signal or a direction controlling signal sent from the vehicle intelligent key device 302.

Preferably, the vehicle controller 303 may comprise a detection module 304 configured to detect whether the vehicle intelligent key device 302 is outside the vehicle 301. The vehicle controller 303 controls the vehicle 301 to execute the corresponding action according to the starting signal or the direction controlling signal only when the vehicle intelligent key device 302 is outside the vehicle 301. Further, a distance between the vehicle intelligent key device 302 and the vehicle 301 is less than or equal to a predetermined distance threshold, for example, 10 meters. In other words, the vehicle intelligent key device 302 should be within a visual range outside the vehicle 301. Within the visual range, the user can control the vehicle 301 through the vehicle intelligent key device 302.

FIG. 4 is a block diagram of the vehicle 301 according to another embodiment of the present disclosure. As shown in FIG. 4, the vehicle 301 further comprises a body control module (BCM) 401, an electric steering column lock (ECL) 402, a gateway 403, an engine control module (ECM) 407, an automatic transmission 405, and an electrical parking brake (EPB) 406. In other embodiments, the vehicle 301 may further comprise a high-frequency receiving module and an antenna. For an electric vehicle, the engine control module 407 may be an electromotor controller 404.

In one embodiment of the present disclosure, the automatic transmission 405 may be a dual clutch transmission (DCT).

In some embodiments of the present disclosure, the vehicle controller 303, the body control module (BCM) 401, the electric steering column lock (ECL) 402, the engine control module (ECM) 407, the electromotor controller 404, the automatic transmission 405, and the electrical parking brake (EPB) 406 may communicate and be electronically connected with one another through the gateway 403.

The body control module (BCM) 401 is configured to receive a starting instruction or a controlling instruction to control the vehicle 301 to power on. The gateway 403 is configured to transmit data and to provide a high or low speed network communication within the vehicle. For example, the high speed may be 500 Kbps (bit per second), and the low speed may be 125 Kbps.

The engine control module (ECM) 407 or the electromotor controller 404 is configured to control the vehicle 301 to output a power. For a fuel vehicle, the dual clutch transmission 405 is configured to control a gearbox of the vehicle to switch automatically and to control a clutch. The electrical parking brake (EPB) 406 is configured to prevent the vehicle 301 from moving when engaged.

More particularly, when a power mode of the vehicle intelligent key device 302 is “OFF,” all of the vehicle doors, the front hatch, and the trunk are closed, and the vehicle is set to a security mode. The vehicle intelligent key device 302 may be effective only when the vehicle intelligent key device 302 is within a predetermined distance range (for example, 10 meters) outside the vehicle 301. If the vehicle intelligent key device 302 is inside the vehicle 301, the vehicle cannot start the remote control mode. Initially, the gearbox may be set to the “Parking” gear, and a parking cable of the electrical parking brake 406 is engaged.

When a user wants to start the remote control mode of the vehicle, the user briefly presses down the locking key 207 of the vehicle intelligent key device 302, and then during a third predetermined time period (for example, 5 seconds), the user presses down the starting key 101 of the vehicle intelligent key device 302 for the first predetermined time period (for example, 2 seconds) to start the vehicle 301. Thus, the vehicle 301 is set to the remote control mode. In one embodiment, an external lighting system, such as a turn signal lamp or a head lamp, of the vehicle 301 blinks when the vehicle 301 is successfully set to the remote control mode.

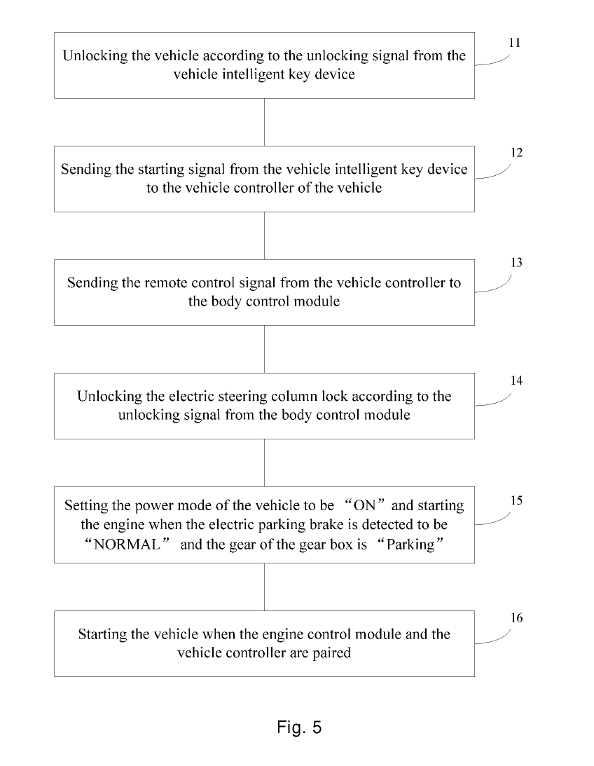

FIG. 5 is a flow chart of a process 500 for starting the remote control mode of the vehicle according to an embodiment of the present disclosure. As shown in FIG. 4 and FIG. 5, for fuel vehicles, starting the remote control mode of the vehicle comprises the following steps.

At step 11, the vehicle 301 is unlocked according to the unlocking signal from the vehicle intelligent key device 302. For example, the user briefly presses down the unlocking key 207 to send the unlocking signal.

At step 12, the starting signal is sent from the vehicle intelligent key device 302 to the vehicle controller 303 of the vehicle 301.

For example, when the user presses down the starting key 101 for the first predetermined time period (for example, 2 seconds) during the third predetermined time period (for example, 5 seconds), the intelligent key device 302 modulates relevant information and sends out the high-frequency starting signal. The high-frequency receiving module of the vehicle 301 receives the high-frequency starting signal and sends the starting signal to the vehicle controller 302 of the vehicle 301 after demodulating the high-frequency starting signal.

At step 13, the remote control signal is sent from the vehicle controller 303 to the body control module 401.

For example, the vehicle controller 302 receives the starting signal from the high-frequency receiving module, unlocks the security mode of the engine according to the starting signal, and then sends the remote control signal to the body control module 401.

At step 14, the electric steering column lock 402 is unlocked according to the unlocking signal sent from the body control module 401.

At step 15, the power mode of the vehicle is set by the body control module 401 to be “ON” and the engine is started when the electric parking brake 406 is detected to be “NORMAL” and the gearbox is set to the “Parking” gear.

At step 16, the engine control module 407 is paired with the vehicle controller 303, and the vehicle is started when the engine control module 407 and the vehicle controller 303 are paired.

For example, when the engine control module 407 and the vehicle controller 303 are paired, the engine control module 407 unlocks the security mode to start the engine.

It should be understood that, for an electrical vehicle, the electromotor controller 404 is paired with the vehicle controller 303. When the electromotor controller 404 and the vehicle controller 303 are paired, a power system of the vehicle is unlocked to start the vehicle 301.

Furthermore, the vehicle will quit the remote control mode if any one of the following conditions is satisfied:
(1) No remote controlling operation is implemented over a fourth predetermined time period (for example, 10 minutes). Thus, the parking cable of the electrical parking brake 406 is engaged, the gearbox is set to the “Parking” gear, the vehicle 301 stops and shuts down, and the electric steering column lock 402 is locked.
(2) The start key 101 is shortly pressed down. Thus, the parking cable of the electrical parking brake 406 is engaged, the gearbox is set to the “Parking” gear, the vehicle 301 stops and shuts down, and the electric steering column lock 402 is locked.
(3) The vehicle intelligent key device 302 is unlocked to open a door of the vehicle 301. Thus, the parking cable of the electrical parking brake 406 is engaged; the gearbox is set to the “Parking” gear, the vehicle 301 stops but does not shut down.
(4) An accelerator pedal or a brake pedal is pressed down. Thus, the gearbox is switched through an operation of a gear shifting mechanism (e.g., a shifting stick), but the vehicle 301 does not shut down.
(5) The vehicle speed is higher than the predetermined threshold speed, for example, 2 km/h, or the vehicle speed signal is faulty. Thus, the vehicle 301 quits the remote control mode, but the vehicle 301 does not shut down.

It is advantageous for quitting the remote control mode in the cases that: the vehicle in the remote control mode is driven by the user; the user forgets to shut down the vehicle, causing the vehicle remain in the remote control mode for a long time; the vehicle loses the remote control function as the direction controlling key fails.

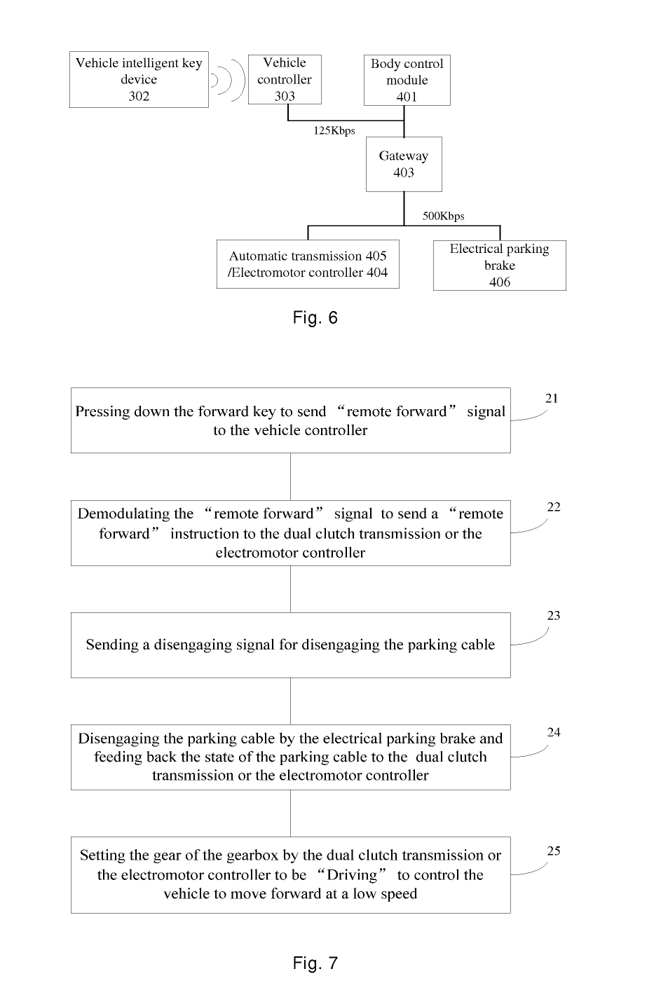

FIG. 6 is a block diagram of the vehicle 301 according to another embodiment of the present disclosure. FIG. 7 is a flow chart of a process 700 for controlling the vehicle to move forward according to an embodiment of the present disclosure.

As shown in FIG. 6 and FIG. 7, controlling the vehicle to move forward comprises the following steps.

At step 21, forward key 201 of the vehicle intelligent key device 302 is pressed down to send a “remote forward” signal to the vehicle controller 303.

At step 22, the “remote forward” signal is demodulated by the vehicle controller 303 to send a “remote forward” instruction to the dual clutch transmission 405 or the electromotor controller 404.

At step 23, a disengaging signal for disengaging the parking cable is sent from the dual clutch transmission 405 or the electromotor controller 404.

At step 24, the parking cable is disengaged by the electrical parking brake 406 according to the disengaging signal and the state of the parking cable is fed from the electrical parking brake 406 to the dual clutch transmission 405 or the electromotor controller 404.

At step 25, the gearbox is set by the dual clutch transmission 405 or the electromotor controller 404 to the “Driving” gear to control the vehicle 301 to move forward at a speed lower than the predetermined speed threshold (for example, 2 km/h).

When the forward key 201 is released, the parking cable is engaged by the electrical parking brake 406 and the gearbox is switched to the “Parking” gear, causing the vehicle 301 to be shut down.

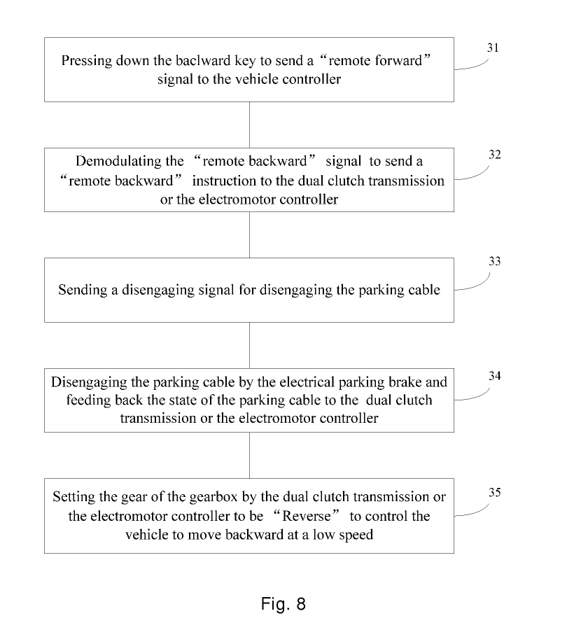

FIG. 8 is a flow chart of a process 800 for controlling the vehicle to reverse according to an embodiment of the present disclosure. As shown in FIGS. 6 and 8, controlling the vehicle to reverse comprises the following steps.

At step 31, the backward key 202 of the vehicle intelligent key device 302 is pressed down to send a “remote backward” signal to the vehicle controller 303;

At step 32, the “remote backward” signal is demodulated by the vehicle controller 302 to send a “remote backward” instruction to the dual clutch transmission 405 or the electromotor controller 404.

At step 33, a disengaging signal for disengaging the parking cable is sent from the dual clutch transmission 405 or the electromotor controller 404 to the electrical parking brake 406.

At step 34, the parking cable is disengaged by the electrical parking brake 406 and the state of the parking cable is returned from the electrical parking brake 406 to the dual clutch transmission 405 or the electromotor controller 404.

At step 35, the gearbox is set by the dual clutch transmission 405 or the electromotor controller 404 to the “Reverse” gear to control the vehicle 301 to reverse at a speed lower than the predetermined speed threshold (for example, 2 km/h).

When the backward key 202 is released, the parking cable is engaged by the electrical parking brake 406 and the gearbox is switched to the “Parking” gear, causing the vehicle 301 to be shut down.

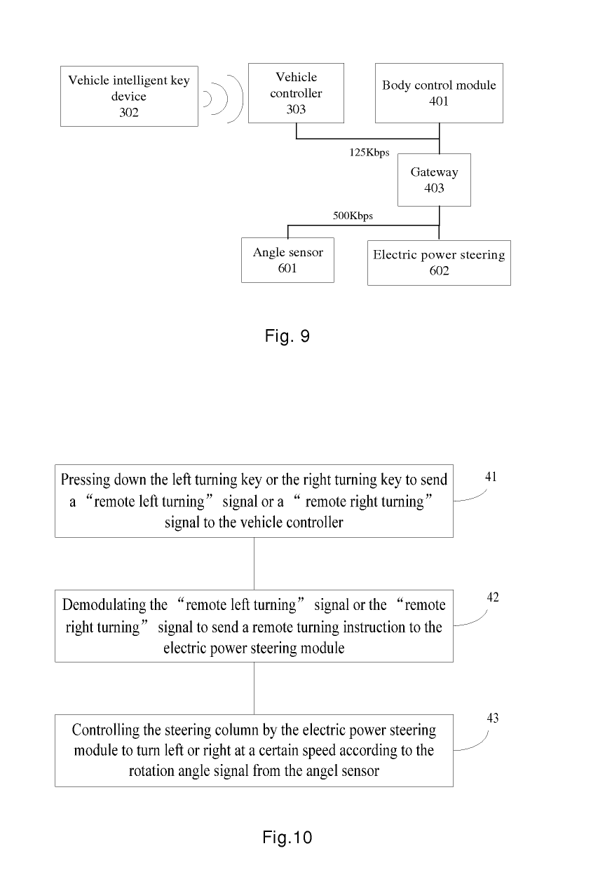

FIG. 9 is a block diagram of the vehicle 301 according to still yet another embodiment of the present disclosure. As shown in FIG. 9, the vehicle 301 may further comprise an angle sensor 601 and an electric power steering (EPS) module 602. The angle sensor 601 is configured to detect a rotation angle of the steering wheel of the vehicle 301 and to send the rotation angle to the electric power steering module 602 so as to control the steering wheel to turn.

FIG. 10 is a flow chart of a process 1000 for controlling the vehicle to turn left or right according to an embodiment of the present disclosure. As shown in FIGS. 9 and 10, controlling the vehicle to turn left or right comprises the following steps.

At step 41, the left turning key 203 or the right turning key 204 of the vehicle intelligent key device 302 is pressed down to send a “remote left turning” or a “remote right turning” signal to the vehicle controller 303.

At step 42, the “remote left turning” or the “remote right turning” signal is demodulated by the vehicle controller 303 to send a remote turning instruction to the electric power steering module 602.

At step 43, the steering column is controlled by the electric power steering module 602 to turn left or right at a certain speed so that the steering wheel is also controlled to turn left or right, according to the rotation angle signal sent from the angle sensor 601.

When the left turning key 203 or the right turning key 204 is released, the steering wheel of the vehicle 301 stops turning left or right.

With the vehicle intelligent key device 302 according to the present disclosure, the user may control a vehicle 301 to move forward or backward at a predetermined speed (for example, 2 km/h) within a visual range (for example, 10 meters). The user may also control the vehicle to turn left or right within the visual range (for example, 10 meters) as desired. Thus, it is convenient for the user to park or take a vehicle in narrow spaces. Furthermore, the operation of the vehicle intelligent key device 302 is simple and convenient.

Reference throughout this specification to “an embodiment,” “some embodiments,” “one embodiment,” or “embodiments,” means that a particular feature, structure, material, or characteristic described in connection with the embodiment or example is included in at least one embodiment or example of the present disclosure. Thus, the appearances of the phrases such as “in some embodiments,” “in one embodiment,” “in embodiments,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present disclosure, and changes, alternatives, and modifications can be made in the embodiments without departing from spirit, principles, and scope of the present disclosure.

What is claimed is:

1. A passenger vehicle intelligent key device, comprising:
a starting key;
a direction controlling key;
a wireless communication module, configured to communicate with a passenger vehicle wirelessly; and
a controlling module, connected to the starting key, the direction controlling key, and the wireless communication module respectively, and configured to control the wireless communication module to send a starting signal or a direction controlling signal to the passenger vehicle when the starting key or the direction controlling key is activated.

2. The passenger vehicle intelligent key device according to claim 1, wherein the direction controlling key comprises at least one of a left turning key, a right turning key, a forward key, and a backward key.

3. The passenger vehicle intelligent key device according to claim 1, further comprising a locking key and an unlocking key connected to the controlling module,
wherein the controlling module is configured to control the wireless communication module to send a locking signal to the vehicle when the locking key is activated and to send an unlocking signal to the passenger vehicle when the unlocking key is activated.

4. The passenger vehicle intelligent key device according to claim 1, further comprising a trunk opening key connected to the controlling module,
wherein the controlling module is configured to control the wireless communication module to send a trunk opening signal to the passenger vehicle when the trunk opening key is activated.

5. The passenger vehicle intelligent key device according to claim 1, further comprising an indicator configured to indicate a status of the vehicle intelligent key device.

6. The passenger vehicle intelligent key device according to claim 1, further comprising a holding key connected to the controlling module,
wherein the controlling module is configured to lock the starting key, the direction controlling key, the locking key, the unlocking key, and the trunk opening key when the holding key is activated.

7. The passenger vehicle intelligent key device according to claim 1, further comprising a transponder configured to communicate with the passenger vehicle when the wireless communication module is interfered.

8. A passenger vehicle control system comprising:
a passenger vehicle intelligent key device configured to transmit a starting signal and a direction controlling signal; and
a passenger vehicle controller, configured to receive the starting signal and the direction controlling signal from the passenger vehicle intelligent key device and to control the passenger vehicle to execute a corresponding action according to the starting signal or the direction controlling signal.

9. The passenger vehicle control system according to claim 8, wherein the passenger vehicle controller comprises a detection module configured to detect whether the passenger vehicle intelligent key device is outside the passenger vehicle.

10. The passenger vehicle control system according to claim 9, wherein if the passenger vehicle controller determines that the vehicle intelligent key device is outside the passenger vehicle, the passenger vehicle controller controls the passenger vehicle to operate according to the starting signal or the direction controlling signal.

11. The passenger vehicle control system according to claim 9, wherein the passenger vehicle controller controls the passenger vehicle to operate when a distance between the passenger vehicle intelligent key device and the passenger vehicle is less than or equal to a predetermined threshold distance.

12. The passenger vehicle control system according to claim 11, wherein the predetermined threshold distance is 10 meters.
